(19) United States
(12) Patent Application Publication
(10) Pub. No.: US 2012/0028202 A1
(43) Pub. Date: Feb. 2, 2012

(54) HEAT TREATMENT DEVICE AND HEAT TREATMENT METHOD

(76) Inventor: Kazuhiko Katsumata, Saitama-shi (JP)

(21) Appl. No.: 13/263,118

(22) PCT Filed: Apr. 8, 2010
(86) PCT No.: PCT/JP2010/002559

§ 371 Date: Oct. 6, 2011

(30) Foreign Application Priority Data
Apr. 10, 2009 (JP) 2009-095892

(51) Int. Cl. F27D 15/02

(52) U.S. Cl. 432/82

(57) ABSTRACT

A heat treatment device of the present disclosure is a heat treatment device including a cooling chamber (120) for cooling a heated treatment object (M), further including: a mist supply portion (20) for supplying a coolant in mist form into the cooling chamber; and a gas supply portion (30) for supplying a gas into the cooling chamber to adjust a flow direction of the coolant in mist form.

### TECHNICAL FIELD

The present invention relates to a heat treatment device and a heat treatment method, for example, to a heat treatment device preferably used for treatments such as hardening of a treatment object. Priority is claimed on Japanese Patent Application No. 2009-095892, filed on Apr. 10, 2009, the content of which is incorporated herein by reference.

### BACKGROUND ART

In heat treatment devices that perform treatments such as hardening by heating and cooling metal materials as treatment objects, cooling apparatuses using an oil cooling system or cooling apparatuses using a gas cooling system are conventionally used in the case where cooling at high speeds is required. In the cooling apparatuses using the oil cooling system, cooling efficiency is excellent. However, it is almost impossible to perform fine cooling control, resulting in a problem in that heat-treatment products are likely to be deformed. On the other hand, in the cooling apparatuses using the gas cooling system, cooling control is easily performed through control of flow rate of a gas or the like. Therefore, despite its excellence in resistance to deformation of heat-treatment products, a problem of low cooling efficiency is posed.

To address this, Patent Document 1 discloses a technique in which a nozzle for liquid and a nozzle for gas are arranged around a heat-treatment product. A coolant is sprayed from the nozzle for liquid (a mist cooling), and a cooling gas is supplied from the nozzle for gas, to thereby make it possible to improve cooling controllability and cooling efficiency.

### BACKGROUND ART LITERATURE

### Patent Literature

Patent Document 1: Japanese Unexamined Patent Application, First Publication No. H11-153386

### DISCLOSURE OF INVENTION

### Problems that the Invention is to Solve

However, the aforementioned prior art has the following problems.

If there is distribution of mist density in the cooling chamber, there may be a difference in cooling characteristics, leading to temperature distribution in the treatment object. Furthermore, if a plurality of treatment objects is treated, there is a possibility of an occurrence of temperature difference among the treatment object in accordance with distribution of the mist density.

If the treatment object has non-uniform temperature distribution as described above, this may be a cause of its deformation. Furthermore, if the treatment object with non-uniform temperature distribution is subjected to a hardening treatment, there is a possibility that the treatment object will not have uniform hardness.

On the other hand, if there is a temperature difference among treatment objects, there is a possibility of difference in quality among the treatment objects, resulting in poor quality.

The present invention has been achieved in view of the aforementioned points, and has an object to provide a heat treatment device and a heat treatment method that are capable of suppressing non-uniform temperature distribution in cooling treatment.

### Means for Solving the Problems

To solve the above problems, the present invention adopts the following.

The present invention is a heat treatment device including a cooling chamber for cooling a heated treatment object, further including: a mist supply portion for supplying a coolant in mist form into the cooling chamber; and an adjustment portion for supplying a gas into the cooling chamber to adjust a flow direction of the coolant in mist form.

In the heat treatment device with the above construction, the coolant in mist form is supplied into the cooling chamber. In addition, the gas is supplied into the cooling chamber. The flow direction of the coolant in mist form is adjusted by the flow of the supplied gas so as to move toward the treatment object. Therefore, it is possible to attach the coolant even to the surface of the treatment object to which it is difficult to attach the coolant due to low mist density.

In the heat treatment device of the present invention, the adjustment portion may supply the gas in multiple directions.

In the heat treatment device with the above construction, even if there are a plurality of surfaces of the treatment objects in which have a small amount of coolant is attached, it is possible to attach a coolant to the surfaces.

In the heat treatment device of the present invention, the adjustment portion may include a modification portion for modifying a supply direction of the gas.

In the heat treatment device with the above construction, the flow direction of the coolant in mist form in the cooling chamber changes as the supply direction of the gas which is modified by the operation of the modification portion.

The heat treatment device of the present invention may further include a transfer portion for transferring the treatment object in a predetermined direction. The adjustment portion may include: pipe bodies which extend along a transfer direction of the transfer portion and into which the gas is introduced; and a plurality of nozzle portions provided in the pipe bodies in a manner spaced from each other in the transfer direction. The modification portion may include on-off valves each provided correspondingly to each of the pipe bodies.

In the heat treatment device with the above construction, the flow direction of the coolant in mist form in the cooling chamber changes as the supply direction of the gas which is modified by the operations of the on-off valves is modified. Furthermore, nozzle portions for supplying the gas are provided in a manner spaced from each other along the transfer direction of the treatment object. Therefore, the directions of flow of the coolant in mist form are adjusted so as to be substantially uniform with respect to the transfer direction.

The heat treatment device of the present invention may further include a control portion for controlling the modification portion so as to modify the supply direction of the gas after passage of a predetermined period of time.

In the heat treatment device with the above construction, the supply direction of the gas is modified after passage of a predetermined period of time. Therefore, after the directions of flow of the coolant in mist form being stable in a predetermined direction, the supply direction of the gas changes to another direction. As a result, it is possible to attach an amount of coolant sufficient for cooling to a predetermined surface of the treatment object.

The heat treatment device of the present invention may further include a control portion for controlling the modification portion so as to modify the supply direction of the gas before passage of a predetermined period of time.

In the heat treatment device with the above construction, the supply direction of the gas is modified before passage of a predetermined period of time. Therefore, the flow of the coolant in mist form in the cooling chamber does not become stable but becomes a turbulent flow. As a result, even in the case where surfaces of the treatment object have a complex shape or a plurality of treatment objects are cooled simultaneously, the coolant in mist form moves as a turbulent flow, to thereby make it possible to attach the coolant to any surface of the treatment object.

The heat treatment device of the present invention may further include: a temperature measurement portion for measuring a temperature of the treatment object; and a second control portion for controlling the modification portion based on a measurement result from the temperature measurement portion.

In the heat treatment device with the above construction, the supply direction of the gas is modified through control of the modification portion by the second control portion based on the measurement result from the temperature measurement portion. Furthermore, as to this modification, the flow direction of the coolant in mist form in the cooling chamber changes.

In the heat treatment device of the present invention, the temperature measurement portion may measure a temperature of the treatment object at multiple sites. Furthermore, the second control portion may control the modification portion based on a difference in measured temperatures among the sites.

In the heat treatment device with the above construction, the supply direction of the gas is modified through control of the modification portion by the second control portion based on a difference in measured temperatures among the sites. Therefore, it is possible to attach the coolant more preferentially to, for example, a higher-temperature surface of the treatment object.

In the heat treatment device of the present invention, the temperature measurement portion may measure temperature of each of the treatment objects. Furthermore, the second control portion may control the modification portion based on a difference in measured temperatures among the treatment objects.

In the heat treatment device with the above construction, the supply direction of the gas is modified through control of the modification portion by the second control portion based on a difference in temperature among the treatment objects. Therefore, it is possible to attach the coolant more preferentially to, for example, a predetermined treatment object at a higher temperature.

In the heat treatment device of the present invention, the gas may be a pressure adjusting gas for adjusting a pressure in the cooling chamber.

In the heat treatment device with the above construction, the flow of the coolant in mist form is directed toward the treatment object by the flow of the supplied pressure supply gas.

In the heat treatment device of the present invention, the gas may be a cooling gas for cooling the treatment object.

In the heat treatment device with the above construction, the flow direction of the coolant in mist form is directed toward the treatment object by the flow of the supplied cooling gas.

A heat treatment method of the present invention, including: a cooling step of cooling a heated treatment object by supplying a coolant in mist form into a cooling chamber; and an adjustment step of adjusting a flow direction of the coolant in mist form by supplying a gas into the cooling chamber.

In the above method, the coolant in mist form is supplied into the cooling chamber. In addition, the gas is supplied into the cooling chamber. The flow direction of the coolant in mist form is adjusted in the above adjustment step by the flow of the supplied gas so as to move toward the treatment object. Therefore, it is possible to attach the coolant even to the surface of the treatment object to which it is difficult to attach the coolant due to low mist density.

In the heat treatment method of the present invention, the gas may be supplied in a plurality of directions.

In the above method, even if there are a plurality of surfaces of the treatment object in which a small amount of coolant is attached, it is possible to attach a coolant to the surfaces.

The heat treatment method of the present invention may further include a step of modifying a supply direction of the gas.

In the above method, the flow direction of the coolant in mist form in the cooling chamber changes as to a modification of the supply direction of the gas.

The heat treatment method of the present invention may further include a step of transferring the treatment object in a predetermined direction. Furthermore, the gas may be introduced into a plurality of pipe bodies and is also supplied into the cooling chamber from a plurality of nozzle portions, the pipe bodies extending along a transfer direction of the treatment object, and the nozzle portions being provided in the pipe bodies in a manner spaced from each other along the transfer direction. Furthermore, the supply direction of the gas may be modified by operations of on-off valves each of which is provided correspondingly to each of the pipe bodies.

In the above method, the flow direction of the coolant in mist form in the cooling chamber changes as to a modification of the supply direction of the gas by the operations of the on-off valves. Furthermore, a plurality of nozzle portions for supplying the gas are provided in a manner spaced from each other along the transfer direction of the treatment object. Therefore, the directions of flow of the coolant in mist form are adjusted so as to be substantially uniform with respect to the transfer direction.

In the heat treatment method of the present invention, the supply direction of the gas may be modified after passage of a predetermined period of time.

In the above method, the supply direction of the gas is modified after passage of a predetermined period of time. Therefore, after the flow direction of the coolant in mist form in the cooling chamber becomes stable in a predetermined direction, the supply direction of the gas changes to another direction. As a result, it is possible to attach an amount of coolant sufficient for cooling to a predetermined surface of the treatment object.

In the heat treatment method of the present invention, the supply direction of the gas may be modified before passage of a predetermined period of time.

In the above method, the supply direction of the gas is modified before passage of a predetermined period of time. Therefore, the flow of the coolant in mist form in the cooling chamber does not become stable and becomes a turbulent flow. As a result, even in the case where surfaces of the treatment object have a complex shape or a plurality of treatment objects are cooled simultaneously, the coolant in mist form flows as a turbulent flow, to thereby make it possible to attach the coolant to any surface of the treatment object.

The heat treatment method of the present invention may further include a measurement step of measuring the temperature of the treatment object. Furthermore, the supply direction of the gas may be changed based on temperature measured in the measurement step.

In the above method, the supply direction of the gas is modified based on the measurement result in the measurement step. Furthermore, as to this modification, the flow direction of the coolant in mist form in the cooling chamber.

In the heat treatment method of the present invention, temperature of the treatment object may be measured at a plurality of sites in the measurement step, and the supply direction of the gas may be modified based on a difference in measured temperatures among the sites of the treatment object.

In the above method, the supply direction of the gas is modified based on a difference in measured temperatures among the sites of the treatment object. Therefore, it is possible to attach the coolant more preferentially to, for example, a higher-temperature surface of the treatment object.

In the heat treatment method of the present invention, temperatures of a plurality of the treatment objects may be measured in the measurement step, and the supply direction of the gas may be modified based on a difference in measured temperatures among the plurality of treatment objects.

In the above method, the supply direction of the gas is modified based on a difference in temperature among the plurality of treatment objects. Therefore, it is possible to attach the coolant more preferentially to, for example, a predetermined treatment object at a higher temperature.

In the heat treatment method of the present invention, a pressure adjusting gas for adjusting a pressure in the cooling chamber may be used as the gas.

In the above method, the direction of the flow of the coolant in mist form is adjusted to be directed toward the treatment object by the flow of the supplied pressure supply gas.

In the heat treatment method of the present invention, a cooling gas for cooling the treatment object may be used as the gas.

In the above method, the flow direction of the coolant in mist form is adjusted to be directed toward the treatment object by the flow of the supplied cooling gas.

### Effects of the Invention

According to the present invention, it is possible to attach a sufficient amount of coolant to a surface of a treatment object on which an amount of attached coolant is small due to a low mist density. Consequently, according to the present invention, it is possible to substantially uniformly cool the surfaces of the treatment object. Therefore, according to the present invention, it is possible to suppress non-uniform temperature distribution in the treatment object when it is cooled, to suppress variation and the like in deformation and hardness, and to avoid an occurrence of poor quality.

### BRIEF DESCRIPTION OF THE DRAWINGS

FIG. 1 is a whole construction view of a vacuum heat-treating furnace.

FIG. 2 is a front cross-sectional view showing a cooling chamber according to a first embodiment.

FIG. 3 is a front cross-sectional view showing a cooling chamber according to a second embodiment.

### BEST MODE FOR CARRYING OUT THE INVENTION

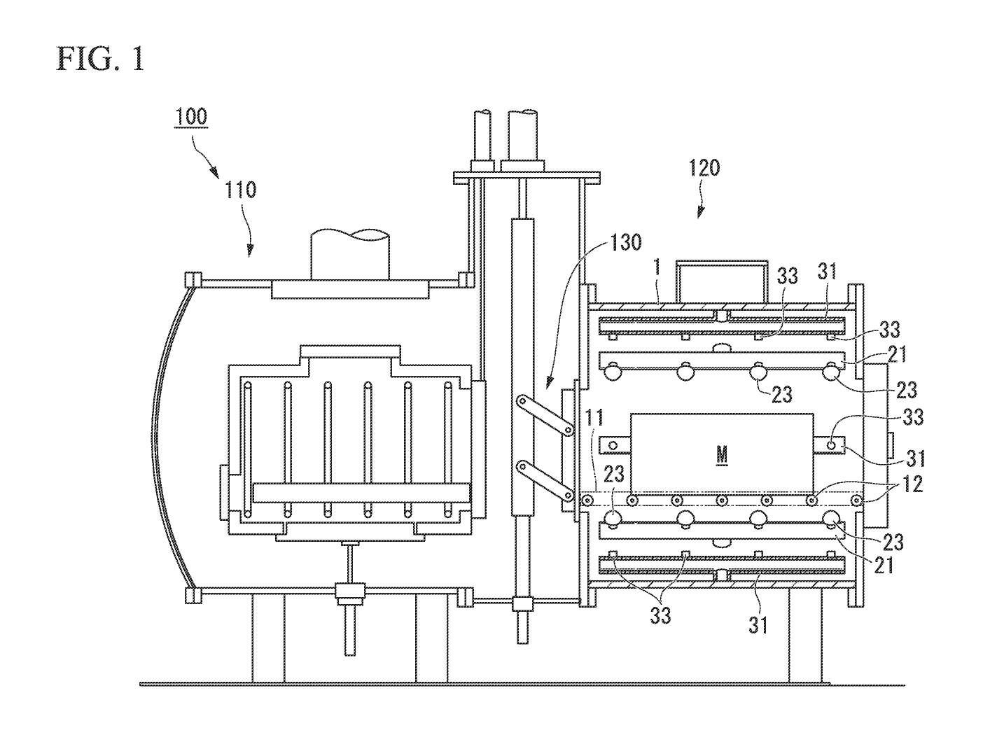

Hereunder is a description of embodiments of a heat treatment device and a heat treatment method according to the present invention with reference to FIG. 1 to FIG. 3. In the drawings used for the following description, the scale of each component has been suitably altered in order to make each component a recognizable size.

Furthermore, in the embodiments, an example of two-chamber-type vacuum heat-treating furnace (hereinafter, simply referred to as “vacuum heat-treating furnace”) will be illustrated as a heat treatment device.

### First Embodiment

FIG. 1 is a whole construction view of a vacuum heat-treating furnace 100 according to the present embodiment.

The vacuum heat-treating furnace (heat treatment device) 100 is an apparatus that subjects a treatment object M to heating treatments such as hardening or the like, in which a heating chamber 110 and a cooling chamber 120 are arranged adjacent to each other. A partition wall 130 is provided between the heating chamber 110 and the cooling chamber 120. When the partition wall 130 is opened, the treatment object M is moved from the heating chamber 110 to the cooling chamber 120, and is then cooled in the cooling chamber 120.

The treatment object M is subjected to heat treatments, one by one, by the vacuum heat-treating furnace 100. The treatment object M is made from a metal material (inclusive of an alloy), such as steel or the like, containing a predetermined amount of carbon. The treatment object M is formed in a substantially rectangular parallelepiped shape.

The present invention is characterized by a cooling treatment in the cooling chamber 120. Therefore, the cooling chamber 120 will be described in detail below.

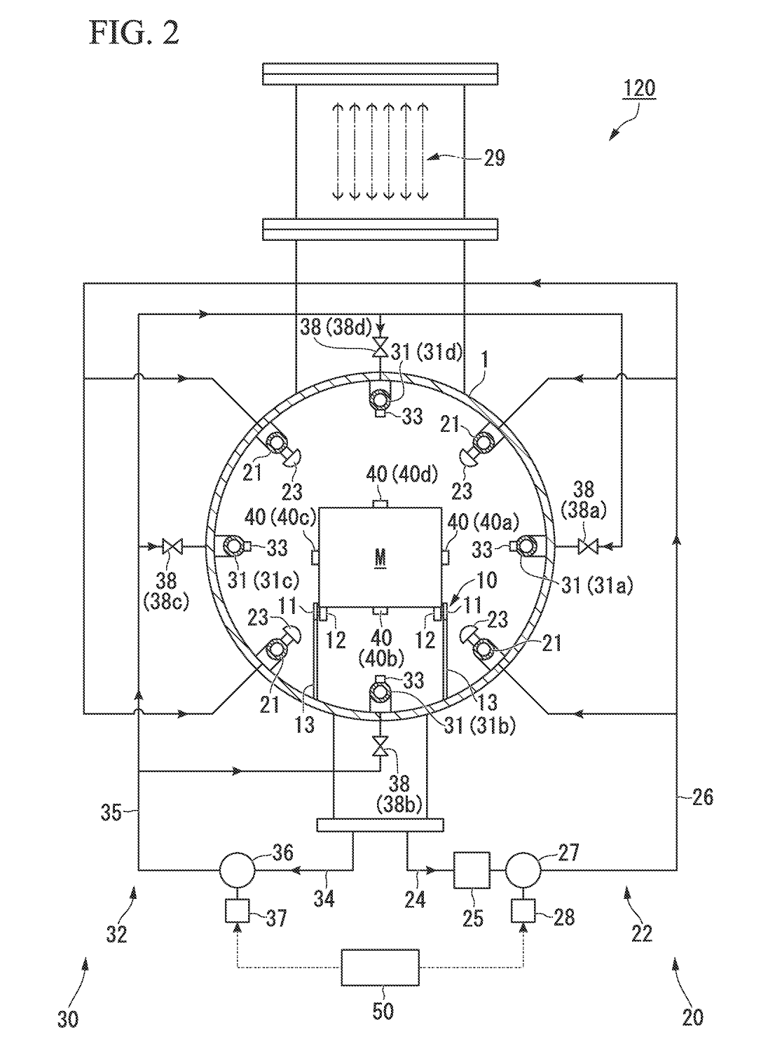

FIG. 2 is a front cross-sectional view of the cooling chamber 120 according to the present embodiment. Hereinafter, the right side in FIG. 2 is referred to simply as “the right side” (the same applies to the left side), and the up side in FIG. 2 is referred to simply as “the up side” (the same applies to the down side).

The cooling chamber 120 has a substantially cylindrical vacuum container 1 that forms outer shell of the cooling chamber 120. Furthermore, in the cooling chamber 120, there are provided: a transfer portion 10; a mist supply portion 20; a gas supply portion (adjustment portion) 30; a temperature measurement portion 40; and a control portion (control portion, second control portion) 50.

The transfer portion 10 is a member for transferring the treatment object M in a predetermined direction along the horizontal direction. The transfer portion 10 includes: a pair of support frames 11; a plurality of rollers 12; and second support frames 13. The pair of support frames 11 are arranged in an opposed manner with a space therebetween, and extend in the transfer direction of the treatment object M. The plurality of rollers 12 are provided rotatably on each of the opposed surfaces of the support frames 11. On each opposed surface of the support frames 11, the rollers 12 are spaced from each other by a predetermined distance in the transfer direction. Each second support frame 13 is provided along the vertical direction, and supports both ends of each support frame 11.

In the following description, the direction in which the treatment object M is transferred by the transfer portion 10 is referred to simply as the transfer direction.

The mist supply portion 20 is a member for supplying a coolant in mist form into the cooling chamber 120 to cool the treatment object M. The mist supply portion 20 includes: a coolant supply pipe 21; and a coolant recovery/supply system 22.

For the coolant of the present embodiment, water, oil, salt or fluorine-based inactive liquid, or the like may be used, for example.

A coolant supply pipe 21 is a tubular member extending in the transfer direction. A plurality of (four, in the present embodiment) coolant supply pipes 21 are substantially evenly spaced (spaced at 90° intervals, in the present embodiment) in the circumferential direction of the vacuum container 1 about a transfer route of the treatment object M by the transfer portion 10. More particularly, the coolant supply pipes 21 are provided at positions spaced at ±45° intervals from the horizontal direction. Each coolant supply pipe 21 is formed over the whole length of the cooling chamber 120 in the transfer direction.

Over the whole length in the length direction of each coolant supply pipe 21, injection portions 23 are provided in a manner spaced from each other by a predetermined distance. The injection portions 23 inject coolant in mist form toward the treatment object M mounted on the transfer portion 10.

The coolant in mist form is influenced by gravity. Therefore, it is preferable that the coolant supply pipes 21 and the injection portions 23 are provided in directions other than the up-down direction, which may produce a difference in supply amount. Furthermore, it is preferable that the coolant supply pipes 21 and the injection portions 23 are provided so that a coolant in mist form is supplied along the horizontal direction. However, if a coolant is supplied along the up-down direction, a different amount of coolant may be supplied in consideration of the influence by gravity. In addition, if not four but three coolant supply pipes 21 are provided, it is preferable that the coolant supply pipes 21 is provided at a zenith position and positions spaced at ±120° intervals from the zenith position in order to decrease the vertical component as much as possible.

The coolant recovery/supply system 22 includes: a drain pipe 24 for recovering the coolant supplied into the cooling chamber 120; a heat exchanger 25, connected to the drain pipe 24, for cooling the recovered drain; ductwork 26 for sending the coolant to the coolant supply pipes 21; a pump 27 for sending the coolant cooled in the heat exchanger 25 to the coolant supply pipes 21 via the ductwork 26; an inverter 28 for controlling an operation of the pump 27 based on instructions from a control portion 50, which will be described below; and a liquefier (liquefaction trap) 29 for liquefying the coolant that has been vaporized by receiving heat from the treatment object M.

The gas supply portion (adjustment portion) 30 supplies a pressure adjusting gas for adjusting a pressure in the cooling chamber 120 into the cooling chamber 120. Furthermore, the gas supply portion (adjustment portion) 30 adjust a flow direction of the coolant in mist form in the cooling chamber 120 by use of the pressure adjusting gas. The gas supply portion 30 includes: a gas supply pipe (pipe body) 31; and a gas recovery/supply system 32.

For the pressure adjusting gas of the present embodiment, for example an inactive gas such as argon, helium, or nitrogen may be used.

A gas supply pipe 31 is a tubular member extending in the transfer direction of the treatment object M. A plurality of (four, in the present embodiment) gas supply pipes 31A are substantially evenly spaced (spaced at 90° intervals, in the present embodiment) in the circumferential direction of the vacuum container 1 about the transfer route of the treatment object M by the transfer portion 10. More particularly, the gas supply pipes 31 are provided at three o'clock, six o'clock, nine o'clock, and twelve o'clock (at top, bottom, left, and right positions) of the vacuum container 1 shown in FIG. 2. Hereinafter, the gas supply pipes 31 are sometimes referred to, in this order, as a first gas supply pipe 31a to a fourth gas supply pipe 31d. Each gas supply pipe 31 is formed over the whole length of the cooling chamber 120 in the transfer direction.

Over the whole length in the length direction of each gas supply pipe 31, nozzle portions 33 are provide that open toward the treatment object M mounted on the transfer portion 10. The nozzle portions 33 are spaced from each other by a predetermined distance.

The gas recovery/supply system 32 includes: an exhaust pipe 34 for recovering the pressure adjusting gas supplied into the cooling chamber 120; ductwork 35 for supplying the pressure adjusting gas to each gas supply pipe 31; a fan 36, connected to the exhaust pipe 34, for supplying the pressure adjusting gas to each gas supply pipe 31 via the ductwork 35; a second inverter 37 for controlling an operation of the fan 36 based on instructions from the control portion 50, which will be described later; and on-off valves (modification portions, on-off valves) 38 each of which is provided in the vicinity of a connection portion of the ductwork 35 with each gas supply pipe 31, and opens/closes based on instructions from the control portion 50. The on-off valves 38 corresponding to the first gas supply pipe 31a to the fourth gas supply pipe 31d are sometimes referred to, in this order, as a first on-off valve 38a to a fourth on-off valve 38d.

In actuality, the fan 36 is made of a bladed wheel and a motor both of which are not illustrated. The second inverter 37 is a member for controlling an operation of the fan 36 by controlling the motor.

The temperature measurement portion 40 is a member for measuring a surface temperature of the treatment object M, and consists of: a first temperature sensor 40a to a fourth temperature sensor 40d. The first temperature sensor 40a to the fourth temperature sensor 40d are provided on surfaces of the treatment object M that respectively faces the first gas supply pipe 31a to the fourth gas supply pipe 31d. The measurement results from the temperature sensors are output to the control portion 50.

For the first temperature sensor 40a to the fourth temperature sensor 40d of the present embodiment, thermocouples are used. However, a plurality of sites of the treatment object M may be measured by non-contact-type thermometers such as radiation thermometers.

The control portion 50 is a member for obtaining measurement results from the temperature measurement portion 40 and also outputting operation instructions to the inverter 28, the second inverter 37, and the on-off valves 38. The control portion 50 outputs operation instructions to the inverter 28 and the second inverter 37 to control the operations of the pump 27 and the fan 36. Thereby, the supply amounts of the coolant and the pressure adjusting gas are adjusted. Furthermore, the control portion 50 is capable of opening the on-off valves 38 independently at predetermined intervals.

Subsequently, a procedure of cooling the heated treatment object M in the cooling chamber 120 in the vacuum heat-treating furnace 100 will be described.

Firstly, the treatment object M heated in the heating chamber 110 is transferred into the cooling chamber 120 by the transfer portion 10.

Next, a coolant in mist form is supplied into the cooling chamber 120.

With an instruction from the control portion 50, the inverter 28 activates the pump 27. Then, the coolant is supplied to the coolant supply pipes 21 via the ductwork 26. The coolant supplied to the coolant supply pipes 21 is sprayed in mist form from the injection portions 23 into the cooling chamber 120. The injection portions 23 inject the coolant in mist form so as to be gradually diffused. Thereby, the coolant in mist form immediately after being sprayed stays around each injection portion 23, and then gradually falls due to the influence of gravity. Namely, only spraying the coolant from the injection portions 23 may result in the mist density in the cooling chamber 120 is distributed.

In the present embodiment, together with the supply of the coolant, the pressure adjusting gas is supplied into the cooling chamber 120.

The second inverter 37 activates the fan 36 by an instruction from the control portion 50. Thereby, the pressure adjusting gas is supplied to the ductwork 35. Here, the control portion 50 opens only a specified on-off valve 38.

For example, as shown in FIG. 2, the control portion 50 opens only the first on-off valve 38a corresponding to the first gas supply pipe 31a provided on the right side of the treatment object M. The pressure adjusting gas is supplied to the first gas supply pipe 31a through the first on-off valve 38a, and is then supplied into the cooling chamber 120 via the nozzle portion 33. Because the nozzle portion 33 opens toward the treatment object M, the pressure adjusting gas is supplied from the nozzle portion 33 of the first gas supply pipe 31a toward the treatment object M. Then, the pressure adjusting gas flows from the nozzle portion 33 in the direction toward the treatment object M.

The flow direction of the coolant in mist form in the cooling chamber 120 is adjusted to be directed toward the treatment object M (adjustment step) by the flow of the pressure adjusting gas. Because a plurality of nozzle portions 33 are provided in the gas supply pipe 31 in a manner spaced from each other with respect to the transfer direction, the directions of flow of the coolant in mist form are adjusted to be substantially uniform with respect to the transfer direction. As a result, the coolant in mist form flows from the nozzle portions 33 of the first gas supply pipe 31a toward the treatment object M. Thus, the coolant in mist form attaches to the right surface of the treatment object M.

The coolant evaporates as it attaches to the surface of the heated treatment object M. At the time of this evaporation, the coolant deprives the treatment object M of heat. Therefore, the surface of the treatment object M to which the coolant has attached is cooled (cooling step). The evaporated coolant is liquefied again in the liquefier 29 for reuse.

The control portion 50 opens the on-off valve 38 for a predetermined period of time.

The predetermined period of time is a span of sufficient time for the pressure adjusting gas supplied into the cooling chamber 120 to form a stable flow, that is, a flow in which the pressure adjusting gas flows in a substantially fixed passage. Therefore, the flows of the pressure adjusting gas and the coolant in mist form become stable. As a result, an amount of coolant sufficient for cooling can be attached to the surface of the treatment object M.

Next, after passage of the predetermined period of time, the control portion 50 switches the on-off valves 38 to be opened.

For example, the control portion 50 closes the first on-off valve 38a, and opens the second on-off valve 38b, instead. With the opening of the second on-off valve 38b, the pressure adjusting gas is supplied from the nozzle portion 33 of the second gas supply pipe 31b, and flows from the bottom portion of the vacuum container 1 toward the treatment object M. Accordingly, the flow direction of the coolant in mist form is adjusted so as to be directed from the bottom portion of the vacuum container 1 toward the treatment object M. Thereby, the coolant in mist form attaches to the lower surface of the treatment object M. Therefore, it is possible to cool the lower surface of the treatment object M by opening the second on-off valve 38b.

Subsequently, similarly to the case of opening the second on-off valve 38b, it is possible to respectively cool the left surface and the upper surface of the treatment object by opening the third on-off valve 38c and the fourth on-off valve 38d.

That is, with the opening of only a specified on-off valve 38 by the control portion 50, a flow of the coolant in mist form is produced in the cooling chamber 120. Therefore, even if there is a part with low mist density, it is possible to attach an amount of coolant sufficient for cooling to the surfaces of the treatment object M.

Furthermore, the control portion 50 finely adjusts the open time of the on-off valve 38.

The temperature measurement portion 40 measures temperatures of the surfaces of the treatment object M, and outputs the measurement results to the control portion 50. From the measurement results, the control portion 50 checks whether there is temperature distribution of the treatment object M or not. If a specified surface has a higher temperature than the other surfaces, the control portion 50 increases the open time of the on-off valve 38 corresponding to the surface with the higher temperature.

For example, if the third temperature sensor 40c measures a temperature higher than those by the other sensors, then the left surface of the treatment object M has a temperature higher than those of the other surfaces. Therefore, the control portion 50 increases the open time of the third on-off valve 38c. As a result, the supply time of the pressure adjusting gas from the nozzle portion 33 of the third gas supply pipe 31c is extended, it is possible to cool the left surface of the treatment object M more preferentially than the other surfaces.

Accordingly, in the present embodiment, the open time of the on-off valve 38 is finely adjusted based on the temperature distribution in the surfaces of the treatment object M, it is possible to cool the surfaces of the treatment object M more uniformly.

Therefore, according to the present embodiment, the following advantageous effects can be obtained.

It is possible to attach a sufficient amount of coolant to a surface of the treatment object M with a small amount of attached coolant due to low mist density. Therefore, according to the present embodiment, it is possible to cool the surfaces of the treatment object M substantially uniformly. As a result, it is possible to suppress temperature distribution of the treatment object M when it is cooled. Consequently, it is possible to suppress variation and the like in deformation and hardness, and hence, to avoid the occurrence of poor quality.

### Second Embodiment

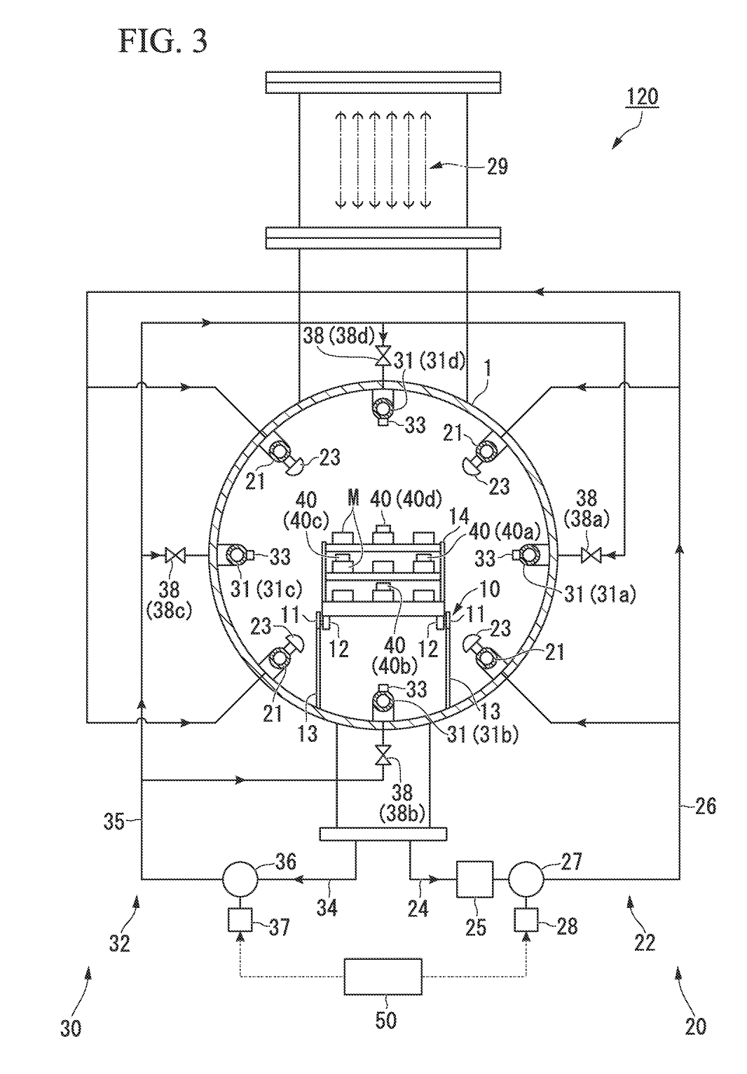

FIG. 3 is a front cross-sectional view of a cooling chamber 120 in the present embodiment.

In the figure, those components which are the same as the components of the first embodiment shown in FIG. 1 and FIG. 2 are denoted by the same reference numerals and description thereof will not be repeated.

The cooling chamber 120 of the present embodiment includes a structure in which a plurality of treatment objects M are cooled in a batch. The treatment object M in the present embodiment is formed with a smaller outer shape than the treatment object M in the first embodiment.

A tray 14 is mounted on rollers 12 of a transfer portion 10. In the tray 14, flow holes for a coolant such as punched holes are formed and arranged in a lattice, and there are provided plate members in a plurality of stages. Treatment objects M are mounted on each stage of the tray 14.

A first temperature sensor 40a of a temperature measurement portion 40 is provided on a treatment object M located on the right side in the tray 14. Similarly, a second temperature sensor 40b, a third temperature sensor 40c, and a fourth temperature sensor 40d are provided on treatment objects M each located respectively on the lower side, the left side, and the upper side in the tray 14. Similarly to the first embodiment, non-contact type thermometers such as radiation thermometers may be used instead of the thermocouple-type temperature sensors.

A control portion 50 in the present embodiment switches the on-off valves 38 to be opened, before passage of a predetermined period of time, that is, a span of sufficient time for the pressure adjusting gas supplied into the cooling chamber 120 to form a stable flow. Therefore, the flow of the pressure adjusting gas does not become stable but become a turbulent state. Because the pressure adjusting gas is in a turbulent state, the flow of the coolant in mist form supplied into the cooling chamber 120 is also become a turbulent state.

In the present embodiment, a plurality of treatment objects M are mounted on the tray 14. Therefore, it is difficult to attach the coolant in mist form to, for example, the treatment object M mounted in the central portion of the tray 14. Consequently, by making the flow of the coolant in mist form in the cooling chamber 120 in a turbulent state, an amount of coolant sufficient for cooling can be attached even to treatment objects M to which it is difficult to attach the coolant.

Note that on-off valves 38 may be opened simultaneously. In this case, the pressure adjusting gas supplied in different directions from the nozzle portions 33 interfere with one another. Therefore, it is possible to make the flow of the coolant in mist form in the cooling chamber 120 in a turbulent state.

Therefore, according to the present embodiment, the following advantageous effects can be obtained.

In cooling treatment objects M, an amount of coolant sufficient for cooling can be attached even to treatment objects M to which it is difficult to attach the coolant. Therefore, it is possible to suppress a difference in temperature among multiple treatment objects M when they are cooled. As a result, it is possible to suppress a variance in hardness and the like, and hence, to avoid an occurrence of poor quality.

While example embodiments of the invention have been described above with reference to the accompanying drawings, it is obvious that these are not to be considered as limitative of the invention. Shapes, combinations and the like of the constituent members illustrated above are merely examples, and various modifications based on design requirements and the like can be made without departing from the spirit or scope of the invention.

For example, in the first embodiment, the on-off valves 38 to be opened are switched after passage of a predetermined period of time. Furthermore, in the second embodiment, the on-off valves 38 to be opened are switched before passage of a predetermined period of time. However, the invention is not limited to these. The first embodiment may use the method of the second embodiment, and vice versa. This is because a more suitable flow state is different according to different surface shapes and the like of the treatment object M.

Furthermore, in the above embodiments, the temperature measurement portion 40 is used to measure the temperature of the treatment object M. However, the invention is not limited to this. Instead of using the temperature measurement portion 40, the on-off valves 38 may be switched at constant intervals measured by the control portion 50 with a timer or the like.

Furthermore, in the above embodiments, for a gas for adjusting the flow direction of the coolant in mist form, the pressure adjusting gas for adjusting the pressure in the cooling chamber 120 is used. However, the invention is not limited to this. The cooling gas for cooling the treatment object M may be used. In this case, a heat exchanger for recooling the cooling gas recovered from the cooling chamber 120 may be installed on the exhaust pipe 34.

### INDUSTRIAL APPLICABILITY

According to the present invention, it is possible to suppress temperature distribution of the treatment object M when it is cooled, to suppress deformation and variation in hardness and the like, and to avoid an occurrence of poor quality.

### DESCRIPTION OF THE REFERENCE NUMERALS

100: vacuum heat-treating furnace (heat treatment device)
120: cooling chamber
10: transfer portion
20: mist supply portion
30: gas supply portion (adjustment portion)
31: gas supply pipe (pipe body)
33: nozzle portion
38: on-off valve (modification portion, on-off valve)
40: temperature measurement portion
50: control portion (control portion, second control portion)
M: treatment object

1. A heat treatment device comprising a cooling chamber for cooling a heated treatment object, further comprising:
a mist supply portion for supplying a coolant in mist form into the cooling chamber; and
an adjustment portion for supplying a gas into the cooling chamber to adjust a flow direction of the coolant in mist form.

2. The heat treatment device according to claim 1,
wherein the adjustment portion supplies the gas in multiple directions.

3. The heat treatment device according to claim 2,
wherein the adjustment portion comprises a modification portion for modifying a supply direction of the gas.

4. The heat treatment device according to claim 3, further comprising
a transfer portion for transferring the treatment object in a predetermined direction,
wherein the adjustment portion comprises: a plurality of pipe bodies which extend along a transfer direction of the transfer portion and into which the gas is introduced; and a plurality of nozzle portions provided in the pipe bodies in a manner spaced from each other in the transfer direction, and
wherein the modification portion comprises on-off valves each provided correspondingly to each pipe body.

5. The heat treatment device in claim 3, further comprising
a control portion for controlling the modification portion so as to modify the supply direction of the gas after passage of a predetermined period of time.

6. The heat treatment device in claim 3, further comprising
a control portion for controlling the modification portion so as to modify the supply direction of the gas before passage of a predetermined period of time.

7. The heat treatment device according to claim 3, further comprising:
a temperature measurement portion for measuring a temperature of the treatment object; and
a second control portion for controlling the modification portion based on a measurement result from the temperature measurement portion.

8. The heat treatment device according to claim 7,
wherein the temperature measurement portion measures a temperature of the treatment object at multiple sites, and
wherein the second control portion controls the modification portion based on a difference in measured temperatures in the treatment object.

9. The heat treatment device according to claim 7,
wherein the temperature measurement portion measures temperatures of the treatment objects; and
the second control portion controls the modification portion based on a difference in measured temperatures among the treatment objects.

10. The heat treatment device according to claim 1,
wherein the gas is a pressure adjusting gas for adjusting a pressure in the cooling chamber.

11. The heat treatment device according to claim 1,
wherein the gas is a cooling gas for cooling the treatment object.

12. A heat treatment method comprising a cooling step of cooling a heated treatment object by supplying a coolant in mist form into a cooling chamber, further comprising
an adjustment step of adjusting a flow direction of the coolant in mist form by supplying a gas into the cooling chamber.

13. The heat treatment method according to claim 12,
wherein the gas is supplied in a plurality of directions.

14. The heat treatment method according to claim 13, further comprising
a step of modifying a supply direction of the gas.

15. The heat treatment device according to claim 14, further comprising
a step of transferring the treatment object in a predetermined direction,
wherein the gas is introduced into a plurality of pipe bodies and is also supplied into the cooling chamber from a plurality of nozzle portions, the pipe bodies extending along a transfer direction of the treatment object, and the nozzle portions being provided in the pipe bodies in a manner spaced from each other along the transfer direction, and
wherein the supply direction of the gas is modified by operations of on-off valves each of which is provided correspondingly to each of the pipe bodies.

16. The heat treatment method according to claim 14,
the supply direction of the gas is modified after passage of a predetermined period of time.

17. The heat treatment method according to claim 14,
the supply direction of the gas is modified before passage of a predetermined period of time.

18. The heat treatment method according to claim 14, further comprising
a measurement step of measuring temperature of the treatment object,
wherein the supply direction of the gas is changed based on temperature measured in the measurement step.

19. The heat treatment method according to claim 18,
wherein a temperature of the treatment object is measured at a plurality of sites in the measurement step, and
wherein the supply direction of the gas is modified based on a difference in measured temperatures of the treatment object.

20. The heat treatment method according to claim 18,
wherein temperatures of a plurality of the treatment objects are measured in the measurement step, and
wherein the supply direction of the gas is modified based on a difference in measured temperatures among the treatment objects.

21. The heat treatment method according to claim 12,
wherein, as the gas, a pressure adjusting gas for adjusting a pressure in the cooling chamber is used.

22. The heat treatment method according to claim 12,
wherein a cooling gas for cooling the treatment object is used as the gas.
